(19) United States
(12) Patent Application Publication
(10) Pub. No.: US 2007/0116853 A1
(43) Pub. Date: May 24, 2007

(54) Coated fat-based confectionery products

(75) Inventors: Martin Krohn, Rellingen (DE); Stefan Reuss, Deutsch Evern (DE); Bernard Trottet, Lerma (MX); Venkata Ramana Sundara, York (GB)

Correspondence Address: BELL, BOYD & LLOYD LLP, P.O. Box 1135, CHICAGO, IL, 60690, US

(73) Assignee: Nestec S.A., Vevey (CH)

(21) Appl. No.: 10/595,335

(22) PCT Filed: Oct. 11, 2004
(86) PCT No.: PCT/EP04/11336

§ 371 Date: Apr. 10, 2006

(30) Foreign Application Priority Data
Oct. 9, 2003 (GB) 0323668.4

(51) Int. Cl. A23G 3/00

(52) U.S. Cl. 426/660

(57) ABSTRACT

This invention concerns a fat-based confectionery product which is coated with a film forming agent and characterised in that it is heat resistant and in that it retains its shape when submitted to heat. This invention also discloses the use of this coated fat-based confectionery in food product, as well as a food product comprising this coated fat-based confectionery, especially chocolate or baked food.

### FIELD OF THE INVENTION

The present invention relates to coated fat-based confectionery products.

### BACKGROUND OF THE INVENTION

It is known to have inclusions such as nuts, raisins, seeds, corn flakes, cookie bits dispersed in various foods like chocolate, cookies, ice cream, yoghurt, among others, in order to give pleasant organoleptic characteristics.

In our co-pending EP-A-781510, we disclose a process to make shaped chocolate pieces dispersed in or distributed on confectionery. The confectionery is a frozen, chilled or ambient confectionery, such as ice cream. The shaped pieces may be inserted into the ice cream using standard equipment without damage by reducing their temperature below 20 or even 15° C. Those shaped pieces can not be heated without losing their shapes.

U.S. Pat. No. 5,344,664 to Kraft discloses low fat chips dispersed in baked goods. The formulation of the chips is especially designed to avoid shape losses when the chips are submitted to warm temperatures. Those chips retain their shapes during baking due to the low fat content, i.e. less than 10%.

EP 909824 to Saint-Louis Sucre discloses the use of a coating to prevent sucrose granules from dissolving in water containing products. The sucrose based granules are fat-free or low-fat.

EP 861603 to Quaker Oats discloses the coating of a snack product with a heat sensitive material and further with a protective coating. In that case, there are no discrete and individualised pieces dispersed into or onto the snack product, but a single layer of a sensitive material enrobing the whole snack.

Film coating is a process of depositing a thin layer of material onto a substrate. It is extensively used in the pharmaceutical industry for coating drugs in single dose form, e.g. tablets. Generally the coatings are applied to protect the drug against light, moisture and oxygen and to mask unpleasant taste or odour. They also can be used to colour the tablets as a form of identification.

Film coating is distinct from hard and soft sugar panning.

In hard sugar panning, successive layers of saturated sugar syrup are spread on tablets or other substrates while they tumble in a revolving drum. The tumbling action spreads the syrup over the surface which then crystallises to form a hard sugar shell. Hard sugar panning is used in both the pharmaceutical industry and the confectionery industry. An example of a hard sugar panned product is Nestlé SMARTIES®.

In soft sugar panning, a non-crystallising sugar syrup is spread on tablets or other substrates while they tumble in a revolving drum. Once the syrup has spread, powder, normally including crystalline sugar, is dosed into the pan to adhere to the wet surface and form the coating. Jelly beans are an example of a soft sugar panned product.

Sugar panned coatings are generally applied to fat based confectionery products at levels of greater than 10% final weight, and more usually between 30 and 50% final weight. Lower application levels produce a thin fragile shell and do not protect the fat based confectionery within. Applying sugar panned coatings to fat based confectionery changes the texture of the fat based confectionery which is not always desirable.

Film coatings provide protection at much lower application levels and do not alter the texture of the coated material.

The visual appearance is a significant part of organoleptic acceptance of a food product. There is also a need for a product which adds to the interest of the children. A food product having dispersed therein recognisable shapes with contrasting colours, can be very attractive for children and also for other people, especially chocolate with fat-based inclusions of recognisable shapes of different colours, or cookies with the same inclusions.

### SUMMARY OF THE INVENTION

The invention relates to film-coated fat-based confectionery products that are heat shape stable and heat resistant. All sides of the product are film coated. Moreover the film-coated fat-based confectionery products can be dispersed into and/or scattered onto a food product such as chocolate, baked products etc. They do not deform when submitted to temperatures higher than ambient, the coating does not crack upon heating, and colour does not bleed from the coating into the food product.

### DETAILED DESCRIPTION OF THE INVENTION

The present invention relates to a confectionery product. A film forming coating is applied to a fat-based confectionery product allowing it to retain its initial shape when submitted to heat in a baking or heating process.

All percentages are expressed by weight unless otherwise specified.

In this invention, “fat-based confectionery product” should be understood as referring to a dark, milk or white chocolate, or to chocolate analogues containing milk fat, milk fat replacers, cocoa butter replacers, cocoa butter substitutes, cocoa butter equivalents, non metabolizable fats or any mixture thereof; or “Caramac® ” sold by Nestlé comprising non-cocoa butter fats, sugar and milk; nut pastes such as peanut butter and fat; and/or praline among others. Fat-based confectionery products may include sugar, milk derived components, and fat and solids from vegetable or cocoa sources, or any other usual ingredient for chocolate such as lecithin for example, in different proportions.

The fat-based confectionery products have in a preferred embodiment a fat content that can vary from 11 to 60%, more preferably 18 to 40% and most preferably 28-35%, and a moisture content less than 10%, more usually less than 5% by weight.

The shape of the fat-based confectionery products can be determined by extrusion die, drop depositing, forming rollers, tablet press, injection moulding, traditional moulding or any other moulding method. In our co-pending EP-A-0603467, a process is described for the cold extrusion of chocolate, which process enables the cost effective production of large quantities of extruded shaped chocolate pieces. The fat-based confectionery product of this invention can be made according to the above mentioned “cold extrusion” process.

Preferably, the shape is a recognisable shape, that is to say a shape which can be identified by a child or an adult or that can be named such as square, ball or discrete pieces such as chips. Examples of recognisable shape are animals, cartoon characters, vehicles, stars, hearts, numbers or letters of the alphabet, dinosaurs, persons, witches hat among others. Example of cartoon characters are Mickey Mouse, Donald Duck, Miss Piggy, and examples of animals are dinosaurs, lions, among others.

If the fat-based confectionery product is made by cold extrusion process described here above, the shape can be flat sided, which means that at least one side of the fat-based confectionery is flat.

The size of the fat-based confectionery may vary and is such that the maximum dimension is not usually greater than 5 cm, preferably not greater than 3 cm, and more preferably not greater than 2 cm.

The film coating can comprise any cellulose-based material such as hydroxypropyl methyl cellulose (HPMC), methyl cellulose (MC), hydroxypropyl cellulose (HPC), carboxy methyl cellulose (CMC) or guar gum, locust bean gum, gum arabic, pectin, xanthan gum, dextrins, maltodextrin, carrageenan, whey protein and/or any mixture thereof. Other water-based or alcohol based formulations can also be used, provided they can film-coat confectionery products.

Preferably the film formulation comprises modified starches, plasticizers, an acidity regulator and emulsifier, dissolved or dispersed in water. Modified starch has to be understood as being starch suitable for human consumption that has been modified by at least one of the following techniques: cross-linking, stabilisation, dextrinisation, enzyme conversion, acid thinning, oxidation, lipophilic substitution, pregelatinisation, thermal treatment, or any other known starch modification.

The plasticiser is used to improve the mechanical properties of the film. Without being bound by theory we believe the plasticiser also prevents cracking on baking. The plasticiser can be any one of propylene glycol, polyethylene glycol, stearic acid, sodium citrate, triethyl citrate, glycerol, glucose syrup, invert syrup, dextrose, fructose, high fructose corn syrup or any mixture thereof and preferably glycerol and/or high fructose corn syrup.

Some combinations of polymers and plasticizers may produce a slightly sticky coating. Polysorbate 80, lecithin, stearic acid, corn starch, talc or other detackifiers may be used to eliminate this problem and Polysorbate 80, lecithin and stearic acid also improve the dispersability and adhesion of the coating onto the fat based confectionery product.

Film coatings using compounds such as sugars, waxes, Shellac or polyols may also be suitable. Supplementary ingredients such as colouring, flavours, minerals, vitamins, prebiotics and/or probiotics can also be added in the film formulation.

The colouring can be any food colouring or mixtures thereof. Typically lake pigments are used as colouring materials in film coating, but dyes can also be applied. For example a green colour can be made by mixing E104 and E133; orange colour with E104, E124, E129, E133, E171; yellow colour with E104, E129, E133, E171; blue colour with E133 and red colour with E104, E124,. Opalescent effects can also be achieved using pigments such as Candurin® from Merck.

Flavours can be chosen amongst known food flavouring, such as chocolate, vanilla, orange, strawberry, cherry, raspberry, nuts, tuttifrutti among others.

The fat-based confectionery product can be coated by any known process of coating : rotating pan, coating drum, spraying, or fluid bed coating for example.

After coating process, the amount of coating is 0.01% to 10% by weight of the coated fat-based confectionery, more preferably 0.5 to 6%, and more preferably 2 to 5%.

The thickness of the coating onto the fat-based confectionery is preferably 1 μm to 1 mm.

The fat-based confectionery product, which is heat sensitive before coating, is rendered shape stable and resistant to heat by the film coating protection.

The fat-based confectionery product without the film coating of the invention is heat sensitive due to the melting of the fat and begins to lose its shape if the temperature is higher than 25° C.

Moreover, with usual fat-based confectionery products used as inclusions in a chocolate or in a baked product, or any other food product submitted to heat during the manufacturing process, there is a leak of colour from the fat-based confectionery into the other food product, chocolate or baked product for example. There also can arise cracks of the coating itself.

For example, it is at present not possible to put chocolate shapes into chocolate because mixing the chocolate shapes into the liquid hot tempered chocolate, which has a temperature of around 29° C. (plus or minus 3° C.), leads to a loss of shape of the chocolate inclusions as the inclusions melt at the contact of the liquid hot tempered chocolate.

Until now, the only method of protecting chocolate shapes to allow them to be used as inclusions in a chocolate or in a baked product has been to hard sugar pan them. However this has significant disadvantages. Adding hard sugar panned chocolate lentil shapes such as SMARTIES® to chocolate tablets significantly alters the texture of the tablet. In addition, only a few shapes can be coated using the sugar panning process, as shapes with flat sides tend to stick together during sugar panning and concave surfaces are not properly coated. These limitations do not occur with film coating.

Some attempts have also been made to use sugar to coat chocolate pieces in order to make them resistant to heat and to use them in baked products, but this has several disadvantages. Coating chocolate pieces in sugar significantly alters their texture.

In the tempering process for moulded or enrobed chocolate products, the tempered chocolate is produced at around 29° C. For chocolate-like materials where tempering is not required it may be desirable to mix in film-coated fat-based confectionery products at temperatures between 30° C. and 40° C .

The film-coated fat-based confectionery product of the present invention is able to be mixed into chocolate and chocolate-like materials at these temperatures without losing its shape, without colour bleeds, without crackings appearing in the coating and without altering the texture of the chocolate or chocolate-like material once set.

Also the protection offered by the sugar shell is poor. For example, SMARTIES® can be dispersed in a cookie dough before baking. As the cookies are baked, the sugar coating begins to dissolve in the dough and the Smarties lose their shapes. The sugar coating cracks as the chocolate expands with heat and there are leaks of colour from the coating into the dough as the dye in the sugar shell, or the coloured sugar shell itself, dissolves in the hot moist environment of the cookie dough. The final cookie after baking is not visually attractive, the shape of the SMARTIES® is no longer regular, the sugar coating has cracked during baking and the colour of the SMARTIES® has bled into the cookie dough.

By film-coating the fat-based confectionery product with a film forming agent, the fat-based confectionery is made shape stable and resistant to heat without altering its texture.

In a cookie during baking, the temperature can vary from 80° C. inside the dough to 200° C. or more on the outside of the cookie. The film-coated fat-based confectionery product of the present invention is able to withstand such high temperatures for sufficient time to bake the cookie without losing its shape, without colour bleed and without the cracking appearing in the coating.

The baked cookie is visually attractive with its coloured inclusions: the initial shape of the fat-based confectionery product is retained.

Therefore, the film-coated fat-based confectionery product keeps its initial shape even in very strong processes for example when it is used in a food which is heated during its manufacturing process.

The film-coated fat-based confectionery product according to the present invention can be dispersed into and/or distributed onto a food product. It can be used in various food products such as chocolate, confectionery, baked products, ice cream, jelly, custard, soft nougat, among others.

Baked products can be cookies, muffins, gingerbread, wafers, waffles or any other flour-based baked product. Other food products wherein the film-coated fat-based confectionery product can be used may be cooked or culinary dishes such as oriental dishes, for example.

The preferred applications are the uses of the film-coated fat-based confectionery products in tempered chocolate, chocolate analogues or in baked goods.

Film-coated fat-based confectionery products of different colours, sizes or flavours can be added into or onto the same food product in order to provide a more attractive visual and organoleptic appearance.

The number or proportion of film-coated fat-based confectionery products according to the invention in and/or on the food product may be chosen as desired in view of the required visual and/or organoleptic effect. Said proportion may be up to 50 or even 70 percent of the final food product, such as from 1 to 70 g and conveniently from 2 to 50 g, or even more preferably between 10 to 25 g per 100 g of the food product.

The following examples are illustrative of some of the products and methods of making the same falling within the scope of the present invention. They are not to be considered in any way limitative of the invention. Changes and modifications can be made with respect to the invention. That is, the skilled person will recognise many variations in these examples to cover a wide range of formulas, ingredients, processing, and mixtures to rationally adjust the naturally occurring levels of the compounds of the invention for a variety of applications.

### EXAMPLES

### Example 1

### White Chocolate Bar with Film-coated Fat-based Stars Inclusions

The heat sensitive fat-based confectionery product is chocolate stars. The chocolate used for the production of the star shapes is “Milky bar buttons”®. The chocolate stars are made according to the cold extrusion process described in our co-pending patent EP-A-781510 and incorporated herein by reference.

The chocolate stars are coated according to the following process. Various coating colourings can be applied so as to obtain coated chocolate stars of different colours.

The coating material is purchased from Sensient Colors UK Ltd. A solution containing 13% of hydroxypropyl methyl cellulose (HPMC) and 87% water is prepared at least 30 minutes before the coating process beginning. A 20 litre portable fluidised bed unit configured for “Wurster” bottom spray coating from FluidAir Inc is used. The coater is connected to an air conditioning unit, which supplies a cool and dry air, for example 20° C. and 30% RH (relative humidity). A batch size of 1 kg is coated at an application level of 1.5 to 2.0% of weight of the finished product.

Once the chocolate stars are film-coated, they are heat resistant and they can retain their shape when heated to temperatures at which the uncoated stars would deform.

Film-coated chocolate stars are then incorporated under mixing in tempered Milky Bar ® white chocolate which contains cocoa butter, vegetable fat, sugar, full cream milk powder, whey powder, lecithin and vanillin. The tempered chocolate is then at temperature of 28° C. The final product is deposited in a mould before cooling.

The chocolate stars keep their shapes during the whole process, including heating, mixing, depositing and cooling and there are no cracks in the coating and no leak of the stars' colouring into the white Milky Bar chocolate and the chocolate tablet has a uniform texture.

### Example 2

### Cookies with Film-coated “Semi-Sweet Morsels” Inclusions

Toll-House Semi-sweet Morsels® are produced with the following ingredients: sugar, cocoa liquor, cocoa butter, milk fat, soy lecithin, vanillin, artificial flavouring, natural flavouring.

10 g lecithin is mixed into 15 g of high fructose corn syrup for 10 minutes so that it is homogeneously distributed. A motorized stirrer is used to stir 200 ml water, into which is added 20 g Instant PureCote™ B792 (a modified starch from Grain Processing Company) and 2 g Sodium Citrate. After stirring for a further 5 minutes, 10 g Crystal Tex™ 626 (a dextrine from National Starch) is added and stirred for a further 5 minutes. The lecithin/high fructose corn syrup mixture is then added and stirred for a further 10 minutes. If a coloured coating is required, colouring material can be added at this point, for example 25 g of a pre-dispersed lake colour, Sensient CSL54096 orange. If any lumps are present, the formulation should be filtered through a fine sieve. The powered stirrer is used to keep the mixture uniformly dispersed during the spraying operation. The film coating mixture is prepared at least 30 minutes before the coating process starts and is stirred continually.

A 20 litre portable fluidised bed unit configured for “Wurster” bottom spray coating from FluidAir Inc is used to coat the Toll-House Semi-sweet Morsels®. The coater is connected to an air conditioning unit, which supplies a cool and dry air, for example 20° C. and 30% RH. A batch size of 1 kg is coated at an application level of 1.5 to 2.0% of weight of the finished product.

The cookie dough is prepared according to the following recipe:
2¼ cups all-purpose flour
1 tea spoon baking soda
1 tea spoon salt
1 cup or 2 sticks of softened margarine or butter
¾ cup packed brown sugar
1 tea spoon vanilla extract
2 large eggs
1 cup chopped nuts
¾ cup granulated sugar.
2 cup of coated Nestle Toll House Semi Sweet Morsels®

Combine flour, baking soda and salt in a mixer. Separately, beat butter, granulated sugar, brown sugar and vanilla extract until creamy. Add eggs one at a time, beating well after each addition. Gradually beat in flour mixture. Stir in coated Toll House Semi Sweet Morsels ® and nuts. Deposit onto ungreased baking moulds, sheets or belt. Bake for 9 to 11 minutes until golden brown at 190-200° C. Cool for 2 minutes before demoulding. Remove to wire racks to achieve complete cooling. The Toll House Semi Sweet Morsels® keep their shapes during the whole process, including mixing, depositing, baking and cooling and there is no cracking of the coating or leak of colouring from the coating into the cookie dough.

1. A heat shape stable and heat resistant fat-based confectionery product comprising a film coating.

2. A fat-based confectionery product according to claim 1 wherein the film coating comprises a coating agent selected from the group consisting of a cellulose-based material modified starch, dextrins, maltodextrin, carrageenan, shellac, whey protein, alcohol-based coating material, other water-based film former and mixtures thereof.

3. A fat-based confectionery product according to claim 1 comprising a plasticiser.

4. A fat based confectionery product according to claim 1 comprising at least one ingredient selected from the group consisting of Polysorbate 80, lecithin, stearic acid, corn starch, talc and mixtures thereof.

5. A fat-based confectionery product according to claim 1 wherein the film coating comprises one or more food colourings and flavourings.

6. A fat-based confectionery product according to claim 1 wherein the film coating is 0.01% to 10% by weight of the fat-based confectionery.

7. A fat-based confectionery according to claim 1 wherein the thickness of the film coating is 1 micrometre to 1 millimetre.

8. A fat-based confectionery product according to claim 1 wherein the product is a chocolate product of less than 15 millimetres width coated with a film comprising a component selected from the group consisting of modified starch, lecithin, high fructose corn syrup and glycerol.

9. A method for producing a food product to be submitted to heat comprising the steps of using a fat-based confectionery product comprising a heat shape stable and heat resistant fat-based confectionery product comprising a film coating.

10. A food product comprising a fat-based confectionery product, a heat shape stable and heat resistant fat-based confectionery product comprising a film coating.

11. A food product according to claim 10 in which the food is selected from the group consisting of a chocolate and chocolate analogue.

12. A food product according to claim 10 having a uniform texture.

13. A food product according to claim 10 wherein the food is selected from the group consisting of a cookie, biscuit, and muffin.

14. A food product according to claim 11 comprising a fat-based confectionery product wherein the product is a chocolate product of less than 15 millimetres width coated with a film comprising a component selected from the group consisting of modified starch, lecithin, high fructose corn syrup and glycerol.

15. A method for providing a food comprising the steps of using fat-based confectionery product comprising a heat shape stable and heat resistant fat-based confectionery product comprising a film coating to produce a product wherein the colouring does not bleed from the coating into or onto the food product.

16. A fat-based confectionery product according to claim 1 wherein the film forming coating agent is selected from the group consisting of hydroxypropyl methyl cellulose, methyl cellulose, hydroxypropyl cellulose, carboxy methyl cellulose, guar gum, locust bean gum, gum arabic, pectin, xanthan gum, and modified starch, dextrins, maltodextrin, carrageenan, shellac, whey protein, alcohol-based coating material, other water-based film former and mixtures thereof.

17. A fat-based confectionery product according to claim 1 which further comprises a plasticiser chosen from the group consisting of polyethylene glycol, stearic acid, sodium citrate, triethyl citrate, glycerol, propylene glycol, glucose syrup, invert syrup, dextrose, fructose, high fructose corn syrup and mixtures thereof.

18. A fat-based confectionery product according to claim 1 wherein the film coating is 0.5 to 6% by weight of the fat-based confectionery.

19. A fat-based confectionery according to claim 1 wherein the film coating is 2 to 5% by weight.

20. A food product according to claim 10 in which food is a flour-based baked food submitted to baking.
